(19) United States
(12) Patent Application Publication
(10) Pub. No.: US 2010/0202821 A1
(43) Pub. Date: Aug. 12, 2010

(54) DEVICES FOR MARKING AND TAGGING BOOKS OR OTHER WRITING SURFACES

(75) Inventor: Alan C. Regala, Seattle, WA (US)

Correspondence Address: FLIESLER MEYER LLP, 650 CALIFORNIA STREET, 14TH FLOOR, SAN FRANCISCO, CA, 94108, US

(73) Assignee: EVERYDAY INNOVATIONS INC., Mountain View, CA (US)

(21) Appl. No.: 12/700,416

(22) Filed: Feb. 4, 2010

Related U.S. Application Data
(60) Provisional application No. 61/150,525, filed on Feb. 6, 2009.

(51) Int. Cl. B43K 29/00; B42D 9/00

(52) U.S. Cl. 401/195; 281/42

(57) ABSTRACT

A device for marking and tagging locations in a book comprises an instrument having a tip to mark a surface, a body, a cap to cover the tip and a strap a strap forming a closed loop. The body includes a shell having a cavity to receive the instrument so that the tip extends past the shell, a bookmark extending away from the shell asymmetrically, the bookmark having a generally flat surface for removably connecting one or more tags, and a latch. The cap includes a bore for receiving the instrument, and a catch received by the latch so that the cap is selectably positionable in two positions. In a first position the tip extends through the bore and past the cap. In a second position the tip is covered by the cap.

### PRIORITY

This application claims priority to U.S. Provisional Patent Application No. 61/150,525, entitled “Thin Writing Instrument,” filed Feb. 6, 2009, which is incorporated herein by reference in its entirety.

### FIELD OF THE INVENTION

Embodiments of the present invention relate to devices for tagging and marking books and writing surfaces, bookmarking locations within books and holding books closed.

### BACKGROUND

Students often take notes and tag pages with scrap paper or temporary adhesive flags while they're reading textbooks or literary books. However, students are sometimes not prepared and don't have a writing instrument and/or flags handy with their book.

It would be useful if a tool were available that made it easier for students and other persons to be more prepared to take notes and/or flag pages.

### SUMMARY

An embodiment of a device for marking and tagging locations in a book in accordance with the present invention comprises an instrument having a tip to mark a surface, a bookmark, a cap to shield the tip, and a strap connected with the bookmark for securing the device to a book and/or surrounding the book and urging the book closed. The device comprises a body including a shell having a cavity to receive the instrument so that the tip extends past the shell. The bookmark is part of the body and extends away from the shell asymmetrically and has a generally flat surface for removably connecting one or more tags. The bookmark can be tapered along at least a portion of the shell so that a width of the bookmark at an end closest to the tip approximately matches a width of the cap so that the bookmark does not interfere with a user's grip of the device. The body also includes a latch to which a catch of the cap connects.

The cap can be selectably positioned in an open position or a closed position, wherein in the open position the tip extends past the cap, and wherein in the closed position the tip is covered by the cap. Optionally, a surface of the cap opposite the instrument is contoured to receive a finger of a writing hand when the device is in use and the cap is textured to reduce slippage when grasping between fingers. The contour and/or texture may provide a more ergonomic grip.

In some embodiments, the device further comprises one or more pads each including a plurality of flags, or alternatively a plurality of repositionable pads. The one or more pads are removably connected with the bookmark as tags and a combined thickness of the bookmark and the one or more pads removably connected with the bookmark is less than a diameter of the shell. The bookmark of the device can optionally include a cut-out so that at least a portion of the one or more pads extends over a portion of the cut-out to improve accessibility of the one or more pads when a user detaches a flag or note.

In some embodiments, the instrument of the device can be one of a ball-point pen, a rollerball pen, a felt-tip pen, a pencil, a highlighter, and a stylus. The shell includes a first portion and a second portion that can be separated to access the instrument. Optionally, a holder can be connected with the instrument with the holder being captured within the shell when the first portion and second portion are attached to resist movement of the instrument within the cavity. Where the shell includes a first portion detachably connected with a second portion to access the cavity, the instrument may be replaceable, for example when the instrument is an ink cartridge that has been expended.

### BRIEF DESCRIPTION OF THE DRAWINGS

FIGS. 1A and 1B are perspective views of an embodiment of a device for marking and tagging locations in a book or other writing surface in accordance with the present invention.

FIGS. 2A-2C illustrate selected uses of the device of FIG. 1.

FIG. 3A is an exploded view of the device of FIG. 1; FIG. 3B is a partial cross-section of a slidable cap for shielding or exposing a writing tool of the device of FIG. 1.

FIGS. 4A-4C are perspective views of alternative embodiments of a device for marking and tagging locations in a book or other writing surface in accordance with the present invention.

FIG. 5A is a perspective view of a further embodiment of a device for marking and tagging locations in a book or other writing surface in accordance with the present invention; FIG. 5B is a side view and partial exploded view of the device of FIG. 5A.

### DESCRIPTION

The following description is of the best modes presently contemplated for practicing various embodiments of the present invention. The description is not to be taken in a limiting sense but is made merely for the purpose of describing the general principles of the invention. The scope of the invention should be ascertained with reference to the claims. In the description of the invention that follows, like numerals or reference designators will be used to refer to like parts or elements throughout.

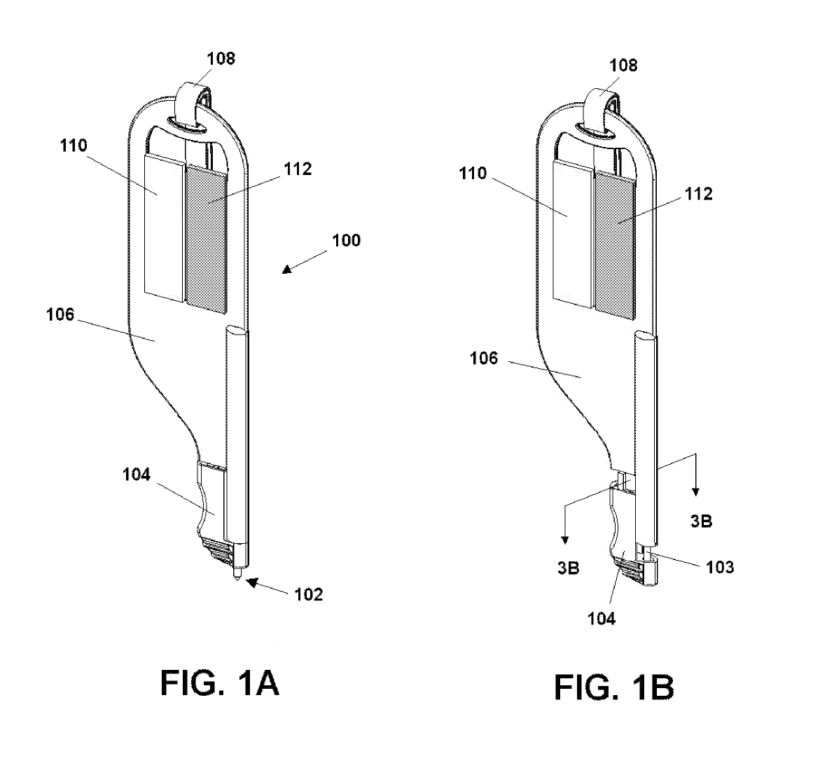

FIGS. 1A and 1B are perspective views of an embodiment of a device for marking and tagging locations in a book or other writing surface in accordance with the present invention. The device 100 includes an ink cartridge 103 that extends along a portion of the length of the device 100 terminating in a pen tip 102 exposable for writing on a surface. As shown, the ink cartridge 103 is a standard mini ballpoint pen refill housed within a cavity of a body of the device 100. Alternatively, the device can include an ink reservoir made from metal or plastic connected with a pen tip, rather than a self contained ink cartridge. Further, the pen tip need not be a ball-point pen tip, but can be of a different type, such as rollerball or felt-tip. Preferably, the thickness of the body along the axis of the ink cartridge 103 is reduced as much as can be practically achieved while securely holding the ink cartridge 103 in a generally rigid or semi-rigid fashion to prevent damaging a book's binding or otherwise transferring unacceptable force to the binding when the pages of a book are closed around the device 100 and the book is urged closed. Typically, a maximum thickness of the device 100 is approximately two to three diameters of a standard mini ballpoint pen refill. For example, in one embodiment a 1/16″ diameter standard mini ballpoint pen refill is held within a body having a thickness of less than about 3/16″ at its thickest point. However, in other embodiments the ink cartridge diameter and relative thickness of the body compared with the diameter of the ink cartridge 103 can be different.

The body of the device 100 forms a bookmark 106 that extends away from the ink cartridge 103 asymmetrically while tapering along the length of the ink cartridge 103 toward the pen tip 102 so as not to obstruct the index finger of a user holding the device 100 in hand with a grip typically used with an ordinary pen or pencil. The bookmark 106 is sufficiently wide near the end of the ink cartridge 103 distal from the pen tip 102 to accommodate tags. As shown, the tags include one or more pads 110, 112 of repositionable, adhesive flags attachable to pages of a book, other writable surfaces such as loose sheets of paper, or any other surface that a user desires to tag. Alternatively, the tags can include repositionable notes, such as sold by 3M under the trademark POST-IT®. While the pen tip allows a user to write directly on surfaces, the user can also place an adhesive flag or note on a page, and use the writing instrument to write on the flag or note, for example if the user does not own a book and does not want to write directly on a page of the book. As shown, the bookmark has a length of 4⅝″ and a width of 1½″ and can accommodate two pads 110, 112 of standard flags refills having standard industry dimensions of 0.47″×1.7″; however, the device need not be limited to the physical dimensions shown. The two pads 100, 112 include flags of different colors to enable tagging for multiple purposes. The bookmark 106 is preferably sufficiently thin so that the combined thickness of the bookmark 106 and pads 110, 112 is not thicker than the maximum thickness of the body along the ink cartridge 103. As shown, each pad 110, 112 includes twenty-five flags and is removably connected with the bookmark 106 so that the flags are conveniently located. The bookmark 106 optionally includes a cut-out 116 over which a portion of the pads extends. The cut-out 116 allows a finger tip to pass through at least partially. The cut-out 116 can substantially improve the ability to urge the end of the pad 10, 12 or the ends of one or more flags away from the bookmark so that a flag can be easily grasped and detached from the pad 10, 12. It also allows the pad 110, 112 to flex downward slightly, which can also reduce a tendency of the pad 10, 12 or flags of the pad to slip from a user's finger while attempting to detach a flag.

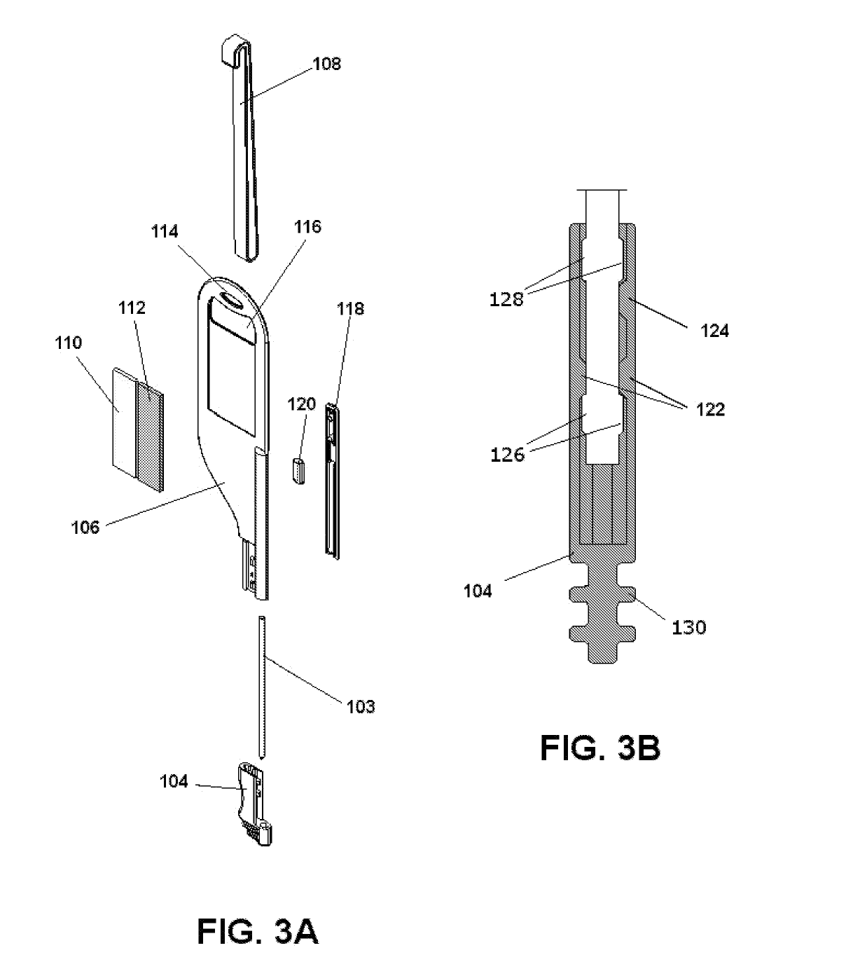

The bookmark 106 terminates so that the pen tip 102 extends from the body of the device 100. A cap 104 is movably connected with the body so that the cap 104 can slide along the axis of the ink cartridge 103. An example of one technique for movably connecting the cap 104 with the body is illustrated in FIG. 3B and described in further detail below. When the cap 104 is slid toward the bookmark 106 so that the cap 104 locks in place at a first position abutting or nearly abutting the bookmark 106, as shown in FIG. 1A, the pen tip 102 is exposed and can be used for writing or otherwise marking a book or other surface. The first position is hereinafter referred to as the open position. When the cap 104 is slid away from bookmark 106 to a second position, as shown in FIG. 1B, the cap 104 covers the pen tip 102 to prevent the pen tip 102 from contacting and unintentionally marking surfaces. The second position is hereinafter referred to as the closed position. In the embodiment shown, the cap 104 is detachable from the device 100 when further urged with sufficient force away from the bookmark 106 to move the cap 104 from the closed position. In some embodiments, when the cap 104 is detached from the device 100 the ink cartridge can be removed from the device 100, for example when empty of ink, and replaced with a refill. The cap 104 preferably has a thickness that does not exceed the maximum thickness of the body. The cap 104 is further shaped so that a surface furthest from the ink cartridge forms a gently curved groove for receiving the end of a finger of the user's hand for urging the body of the device against the hand between the thumb and index finger and for steadying the device 100 when writing.

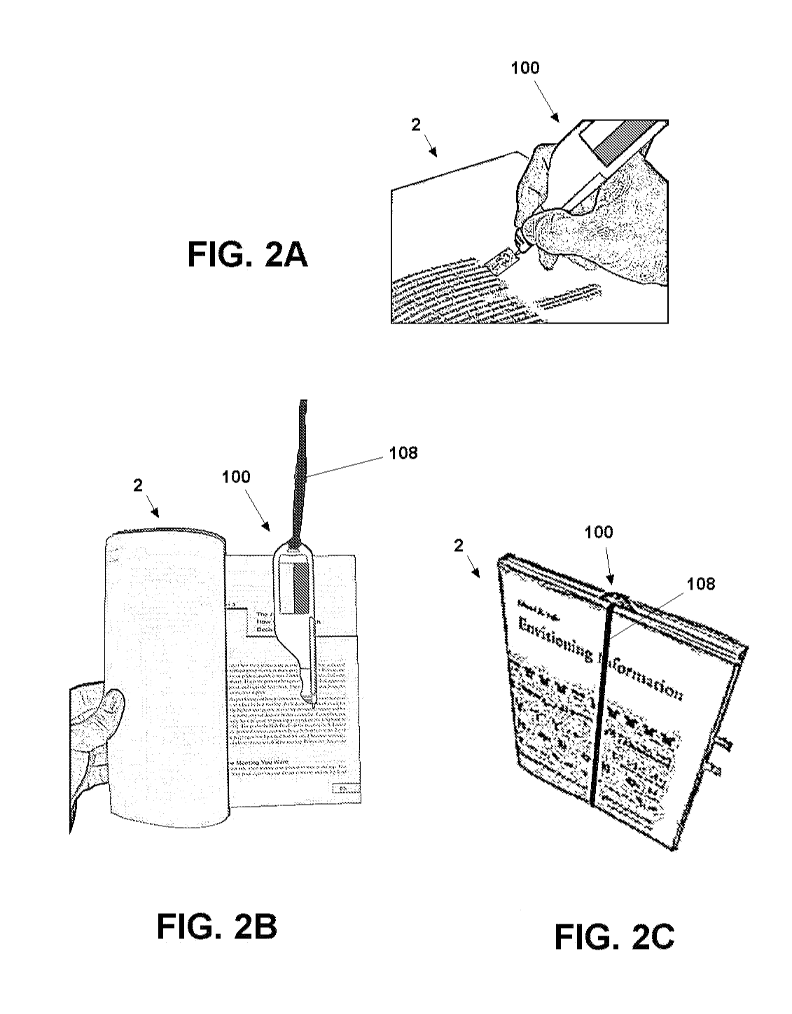

FIGS. 2A-2C illustrate use of a device as shown in FIGS. 1A and 1B. The device 100 can be seen in use in FIG. 2A, with the index figure placed in the groove of the cap 100, which is in a open position, the thumb resting against the side of the cap 104 and the body of the device 100 cradled against the hand. The pen tip is exposed and is shown being used to write on a flag placed in a book 2. Referring again to FIG. 1A, the bookmark 106 further includes a hole 114 for attaching a strap 108 which forms a loop, which is preferably but not exclusively elastic. When a user is finished marking and tagging, the device 100 can be left in a book 2 or collection of papers with the device 100 extending from an edge, as shown in FIG. 2B. The book 2 or collection of papers can then be closed around the device 100 and the strap 108 extending from edge can be stretched from end to end so that the book 2 or collection of papers is held between the elastic loop of the strap 108. The strap 108 functions to both hold the device 100 in place, preventing it from slipping out, and also to keep the book 2 closed, or the collection of papers bound together.

FIG. 3A is an exploded view of the device 100 of FIGS. 1A-2C. In the embodiment shown, the body includes the bookmark 106 and a first part of a shell that defines a cavity for receiving an ink cartridge 103. A second part of the shell 118 is mateable with the first part to enclose the ink cartridge 103. A retaining piece (also referred to herein as a holder) 120 is affixed to the ink cartridge 103 and secures the ink cartridge 103 in place within the shell. As mentioned above, in an embodiment the ink cartridge 103 can be a standard mini ballpoint pen refill. Optionally, the shell can be made detachable into the first and second parts to allow the ink cartridge to be replaced. Alternatively, the ink cartridge can be non-replaceable.

The body is preferably formed from a commercial plastic, for example high density polyethylene (HDPE), using conventional manufacturing techniques (e.g., injection molding, compression molding, etc.). Alternatively, the body can be formed of some other material (or combination of materials) using the same or different manufacturing techniques, for example the body can be formed by die-cast metal. In still further embodiments, a cavity for receiving the ink cartridge can be formed in the body as a single integral piece rather than as a two-piece shell. In such embodiments the ink cartridge can be seated within the cavity using a technique other than a retaining piece, for example the ink cartridge can be press fit into the cavity. One of ordinary skill in the art, upon reflecting on the teachings provided herein, will appreciate the myriad different materials and manufacturing techniques with which embodiments of devices in accordance with the present invention can be formed. Fabrication of the device need not be limited to that described herein or inferred from the exploded view of FIG. 3A.

FIG. 3A further shows the pads 110, 112 which can be adhesively affixed to the bookmark 106. As shown, the bookmark 106 includes a slight depression or scoring outlining where the pads 110, 112 are preferably received, for example to take advantage of the cut-out 116 when detaching flags. The strap 108 can be attached to the hole 114 by looping the strap through the hole and passing the loop of the strap 108 through itself. Alternatively, the strap 108 can be fixed in place using other techniques, for example the strap can be past through the hole 114 and sewn closed or adhesively bonded around the body. In still other embodiments, the hole 114 need not be closed. For example, the hole can include an opening in which the strap can be positioned by folding or pinching the strap, the opening being sufficiently small as to resist the strap from slipping out of the hole when not folded or pinched. Alternatively, a strap can be secured to the device without a hole, for example by insert molding the body over the ends of the strap or pinching ends of the strap with crushable portions of the body. There are myriad different techniques for attaching a strap 108 to the body of the device 100 so that the strap 108 remains sufficiently secure to the device 100 without undesirably reducing the ability of the strap to expand to hold a book closed or a collection of pages together.

FIG. 3A also shows the cap 104 separated from the body. The partial cross-section of FIG. 3B illustrates one technique for movably attaching the cap 104 to the body. The cap 104 can include protuberances 122, 124 that interfere with complementary protuberances 126, 128 of the body. The protuberances 122, 124 of the cap 104 can be considered latches and are positioned between the protuberances 126, 128 of the body which act as catches when the cap is in the closed position (i.e., covering the pen tip), while the trailing protuberance 128 of the body is positioned between the protuberances 122, 124 of the cap 104 when the cap 104 is in the open position (i.e., against the bookmark 106 with the pen tip 102 exposed). In both positions, the complementary protuberances hold the cap 104 in position unless sufficient force is applied to the cap 104 to cause the complementary protuberances to pass over each other. As shown, the protuberances have leading and trailing edges that are ramped. When a protuberance 122, 124 of the cap 104 is urged with sufficient force against a protuberance 126, 128 of the body, the sides of the cap 104 are urged apart so that the protuberance 122, 124 passes over the protuberance 126, 128 of the body to the desired position.

The amount of effort or force required to urge the cap 104 from the open to closed position or vice-versa can be determined, in part, by the profiles of the protuberances. For example, if the slope of the ramped portion of the protuberance is steeper, more force may be required to pass the protuberance of the cap 104 over that of the body, while a shallower slope can reduce the force required to pass the protuberance of the cap 104 over that of the body. While shown as ramped features, the protuberances can have other profiles, such as rounded profiles. Further, while the term “complementary” is used to described protuberances the engage one another, the protuberances need not have the same profile.

The amount of effort or force required to urge the cap 104 from the open to closed position or vice-versa can also be determined by the number of protuberances. As shown, a single protuberance 124 controls how much force need be applied to the cap 104 to move between the open and closed positions. However the force required to separate the cap 104 from the body is larger than the force required to move between open and closed positions because the cap 104 includes a pair of protuberances 122 that must be urged past complementary protuberances 126 of the body.

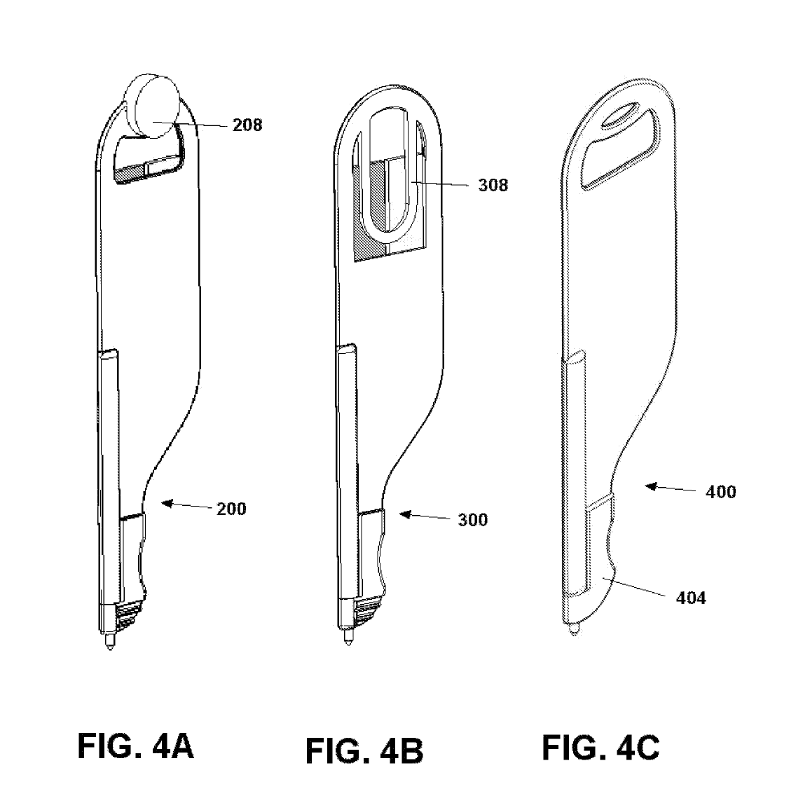

Further, as can be seen in FIGS. 1A-3A and more clearly in partial cross-section of FIG. 3B, the cap 104 includes fins 130 that can improve the ability of a user to grip the cap 104. In other embodiments, for example as shown in FIG. 4C, the cap 104 need not includes such fins 130.

One of ordinary skill in the art, upon reflecting on the teachings provided herein, will appreciate the myriad different modifications that can be made to the device of the previously described embodiment of FIGS. 1A-3B. FIGS. 4A-4C illustrate alternative embodiments of a device for marking and tagging locations in a book or other writing surface in accordance with the present invention. The device 200 shown in FIG. 4A resembles the device 100 of FIG. 1A; however, the device includes a magnet 208 in place of a strap and hole for receiving the strap allowing the device 200 to be attached to a metal surface, such as a refrigerator or filing cabinet. The device 300 shown in FIG. 4B resembles the device 100 of FIG. 1A; however, the device includes a clip 308 in place of a strap and hole for receiving the strap allowing the device 300 to be held within a book, for example, without the use of a strap. The device 400 shown in FIG. 4C resembles the device 100 of FIG. 1A; however, the device includes a cap 404 having a smooth surface free of fins.

While the embodiments shown in FIGS. 1A-4C and described above include devices that use ink cartridges for marking a book or other surface, in still further embodiments, the device can include some other instrument. For example the device can include pencil lead, permanent marker, crayon, or a stylus, such as used with a personal data assistance (PDA). Embodiments of the invention are not intended to be limited to the instruments described herein.

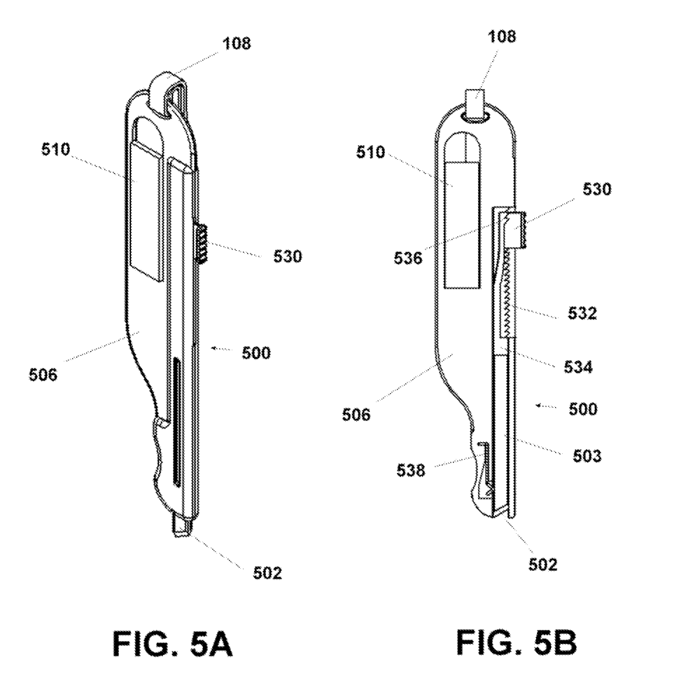

Referring to FIGS. 5A and 5B, further embodiment of a device 500 for marking and tagging locations in a book or other writing surface in accordance with the present invention is shown. The device includes an extendable felt-tip marker (also referred to herein as a highlighter) 503 which is used to draw attention to sections of documents by marking them with a vivid, translucent color. As shown, the device 500 includes a single pad 510 of flags adhesively connected with a bookmark 506 of the device and a strap 108 similar to the strap of FIG. 1A and similarly connected with the body of the device 500. The device 500 does not include a movable cap, although the bookmark 506 tapers in a similar fashion as previous embodiments. A contoured groove extends from the bookmark 506 as part of the body of the device 500 and resembles the contoured shape of the cap of previous embodiments. A book or other surface is shielded from a tip 502 of the highlighter 503 by a mechanism that allows the highlighter 503 to be moved along its axis so that the tip 502 can be retracted into the body of the device 500. The partial cut-away view of FIG. 5B shows the mechanism including a slider 534 with teeth 536 that mate with teeth 532 of the body to resist movement. When a button 530 connected with the slider 534 is pressed, the teeth 536 of the slider 534 no longer engage the teeth 532 of the body, and the slider 534 can be moved. The highlighter 503 is connected with the slider 534 so that the highlighter 503 moves with the slider 534. A leaf spring 538 helps guide the highlighter 503. As will be appreciated, pencil lead could be dispensed using a similar mechanism, or alternatively using a ratchet as used in typical mechanical pencils.

The previous description of the preferred embodiments is provided to enable any person skilled in the art to make or use the embodiments of the present invention. While the invention has been particularly shown and described with reference to preferred embodiments thereof, it will be understood by those skilled in the art that various changes in form and details may be made therein without departing from the spirit and scope of the invention.

1. A device for marking and tagging locations in a book comprising:
an instrument having a tip to mark a surface;
a body including:
a shell having a cavity to receive the instrument so that the tip extends past the shell,
a bookmark extending away from the shell, the bookmark having a generally flat surface for removably connecting one or more tags, and
a latch;
a cap including a catch received by the latch so that the cap is selectably positionable in a first position and a second position,
wherein in the first position the tip extends past the cap;
wherein in the second position the tip is covered by the cap; and
a strap connected with the bookmark and forming a closed loop.

2. The device of claim 1 further comprising:
one or more pads each including a plurality of flags or a plurality of repositionable notes;
wherein the flags or repositionable notes are removably connected with the bookmark as tags; and
wherein a combined thickness of the bookmark and the one or more pads removably connected with the bookmark is less than a diameter of the shell.

3. The device of claim 2 wherein:
the bookmark includes a cut-out; and
at least a portion of the one or more pads extends over a portion of the cut-out to improve accessibility of the one or more pads when a user detaches a tag.

4. The device of claim 1 wherein:
the instrument is one of a ball-point pen, a rollerball pen, a felt-tip pen, a pencil, a highlighter, and a stylus.

5. The device of claim 1 wherein:
the shell includes a first portion detachably connected with a second portion to access the cavity; and
the instrument is replaceable by accessing the cavity.

6. The device of claim 5 further comprising:
a holder and wherein the instrument is received in the holder and the holder is captured within the shell when the first portion and second portion are attached to resist movement of the instrument within the cavity.

7. The device of claim 1 wherein:
the bookmark is tapered along at least a portion of the shell so that a width of the bookmark at an end closest to the tip approximately matches a width of the cap.

8. The device of claim 1 wherein:
a surface of the cap opposite the instrument is contoured to receive a finger of a writing hand when the device is in use and the cap is textured to reduce slippage when grasping between fingers.

9. A device for marking and tagging locations in a book comprising:
an instrument having a tip at a distal end to mark a surface;
a body including:
a bookmark having a width extending from a first edge to a second edge and a generally flat surface for removably connecting one or more tags,
a shell connected with the bookmark along the first edge of the bookmark, the shell having a cavity to receive the instrument so that the tip extends past the shell,
wherein the width of the bookmark tapers from the second edge toward the first edge along at least a portion of the shell.

10. The device of claim 9 further comprising:
a latch extending from a distal end of the bookmark;
a cap received by the latch so that the cap is slidably positionable in an open position and a closed position;
wherein in the open position the tip extends past the cap;
wherein in the closed position the tip is covered by the cap.

11. The device of claim 10 wherein:
a surface of the cap is contoured to receive a finger of a writing hand when the device is in use; and
the cap is textured to reduce slippage when grasping between fingers.

12. The device of claim 9 further comprising:
a strap connected with the bookmark and forming a closed loop.

13. The device of claim 9 further comprising:
a magnet connected with the bookmark to removably attach the device to a metal surface.

14. The device of claim 9 further comprising:
a clip connected with the bookmark.

15. The device of claim 9 further comprising:
one or more pads each including a plurality of flags or a plurality of repositionable notes;
wherein the one or more pads are removably connected with the bookmark as tags; and
wherein a combined thickness of the bookmark and the one or more pads removably connected with the bookmark is less than a diameter of the shell.

16. The device of claim 9 wherein:
the instrument is one of a ball-point pen, a rollerball pen, a felt-tip pen, a pencil, a highlighter, and a stylus.

17. The device of claim 9 wherein:
the shell includes a first portion detachably connected with a second portion to access the cavity; and
the instrument is replaceable by accessing the cavity.

18. A device for marking and tagging locations in a book comprising:
an instrument having a tip at a distal end to mark a surface;
a body including:
a bookmark having a width extending from a first edge to a second edge and a generally flat surface for removably connecting one or more tags,
a shell connected with the bookmark along the first edge of the bookmark, the shell having a cavity to receive the instrument so that the tip extends past the shell,
wherein the width of the bookmark tapers from the second edge toward the first edge along at least a portion of the shell; and
a slider extending from the cavity outside of the shell and movable along at least a portion of the length of the shell, the slider being attached to the instrument so that a distance that the tip extends past the shell can be adjusted by moving the slider; and
a strap connected with the bookmark and forming a closed loop.

19. The device of claim 18, wherein:
the slider includes a button and a row of teeth engageable with teeth of the shell extending into the cavity; and
the button disengages the slider teeth from the shell teeth.

20. The device of claim 18 further comprising:
one or more pads each including a plurality of flags or a plurality of repositionable notes;
wherein the one or more pads are removably connected with the bookmark as tags; and
wherein a combined thickness of the bookmark and the one or more pads removably connected with the bookmark is less than a diameter of the shell.

21. The device of claim 18 wherein:
the instrument is one of a ball-point pen, a rollerball pen, a felt-tip pen, a pencil, a highlighter, and a stylus.

22. The device of claim 18 wherein:
the shell includes a first portion detachably connected with a second portion to access the cavity; and
the instrument is replaceable by accessing the cavity.
